(19) United States
(12) Patent Application Publication
(10) Pub. No.: US 2025/0172923 A1
(43) Pub. Date: May 29, 2025

(54) HIERARCHAL CASCADING SAFETY SIGNATURES FOR INDUSTRIAL AUTOMATION APPLICATIONS

(71) Applicant: ROCKWELL AUTOMATION TECHNOLOGIES, INC., MAYFIELD HEIGHTS, OH (US)

(72) Inventors: Nicholas L. Stay, Milwaukee, WI (US); Joseph P. Izzo, New Berlin, WI (US)

(21) Appl. No.: 18/960,823

(22) Filed: Nov. 26, 2024

Related U.S. Application Data
(60) Provisional application No. 63/603,909, filed on Nov. 29, 2023.

(51) Int. Cl. G05B 19/406

(52) U.S. Cl. CPC G05B 19/406; G05B 2219/50193

(57) ABSTRACT

Systems, methods, and media for hierarchal, cascading safety signatures for industrial automation applications. A method includes receiving a first user input including a safety configuration for a safety controller; generating an aggregate safety signature indicative of the safety configuration for the safety controller including a parent safety signature element and a first child safety signature element; receiving a second user input provided to the user interface including a modification to the safety configuration; generating a second child safety signature element based on the modification; updating the aggregate safety signature based on the second child safety signature element; and causing the safety controller to operate in accordance with the safety configuration and the aggregate safety signature.

### CROSS-REFERENCE TO RELATED APPLICATION

This application claims the benefit of and priority to U.S. Provisional Patent Application No. 63/603,909, filed on Nov. 29, 2023, the entire disclosure of which is incorporated herein by reference.

### BACKGROUND INFORMATION

Industrial automation environments can include safety systems that are used to shut down equipment and protect individuals working in the industrial automation environment. Systems, devices, methods, and media that can be used to provide more dynamic safety functionality in industrial automation environments are generally desired.

### BRIEF DESCRIPTION

One aspect of the disclosure is a method in a control system. The method includes receiving a first user input provided to a user interface including a safety configuration for a safety controller in the control system; generating an aggregate safety signature indicative of the safety configuration for the safety controller, the aggregate safety signature including a parent safety signature element and a first child safety signature element associated with the parent safety signature element; receiving a second user input provided to the user interface including a modification to the safety configuration for the safety controller in the control system; generating a second child safety signature element associated with the parent safety signature element based on the modification to the safety configuration for the safety controller; updating the aggregate safety signature based on the second child safety signature element; and causing the safety controller in the control system to operate in accordance with the safety configuration and the aggregate safety signature.

Another aspect of the disclosure is a system. The system includes memory to store instructions and processing circuitry to execute the instructions to receive a first user input including a safety configuration for a safety controller in a control system; generate an aggregate safety signature indicative of the safety configuration for the safety controller, the aggregate safety signature including a parent safety signature element and a first child safety signature element associated with the parent safety signature element; receive a second user input including a modification to the safety configuration for the safety controller in the control system; generate a second child safety signature element associated with the parent safety signature element based on the modification to the safety configuration for the safety controller; update the aggregate safety signature based on the second child safety signature element; and cause the safety controller in the control system to operate in accordance with the safety configuration and the aggregate safety signature.

Yet another aspect of the disclosure is a non-transitory computer-readable storage medium. The non-transitory computer-readable storage medium has instructions stored thereon that, when executed by processing circuitry, cause the processing circuitry to receive a first user input provided to a user interface including a safety configuration for a safety controller in a control system; generate an aggregate safety signature indicative of the safety configuration for the safety controller, the aggregate safety signature including a parent safety signature element and a first child safety signature element associated with the parent safety signature element; receive a second user input provided to the user interface including a modification to the safety configuration for the safety controller in the control system; generate a second child safety signature element associated with the parent safety signature element based on the modification to the safety configuration for the safety controller; update the aggregate safety signature based on the second child safety signature element; and cause the safety controller in the control system to operate in accordance with the safety configuration and the aggregate safety signature.

### BRIEF DESCRIPTION OF THE DRAWINGS

FIG. 1 is a block diagram showing components of an example industrial control system, in accordance with some aspects of the disclosure.

FIG. 2 an illustration of an example an example safety signature that can be used by the control system of FIG. 1, in accordance with some aspects of the disclosure.

FIG. 3 is an example table showing safety signature element hierarchy within the control system of FIG. 1, in accordance with some aspects of the disclosure.

FIG. 4A is an illustration of an example quick view pane user interface associated with the control system of FIG. 1, in accordance with some aspects of the disclosure.

FIG. 4B is an illustration of another example quick view pane user interface associated with the control system of FIG. 1, in accordance with some aspects of the disclosure.

FIG. 5 is an illustration of an example safety signature report user interface associated with the control system of FIG. 1, in accordance with some aspects of the disclosure.

FIG. 6 is an illustration of an example safety signature compare tool user interface associated with the control system of FIG. 1, in accordance with some aspects of the disclosure.

FIG. 7 is a flow diagram illustrating an example process for generating using hierarchal cascading safety signatures that can be implemented in the control system of FIG. 1, in accordance with some aspects of the disclosure.

FIG. 8 is a diagram illustrating an example hierarchal relationship between an aggregate safety signature and its associated parent and child safety signature elements that can be used in the control system of FIG. 1, in accordance with some aspects of the disclosure.

### DETAILED DESCRIPTION

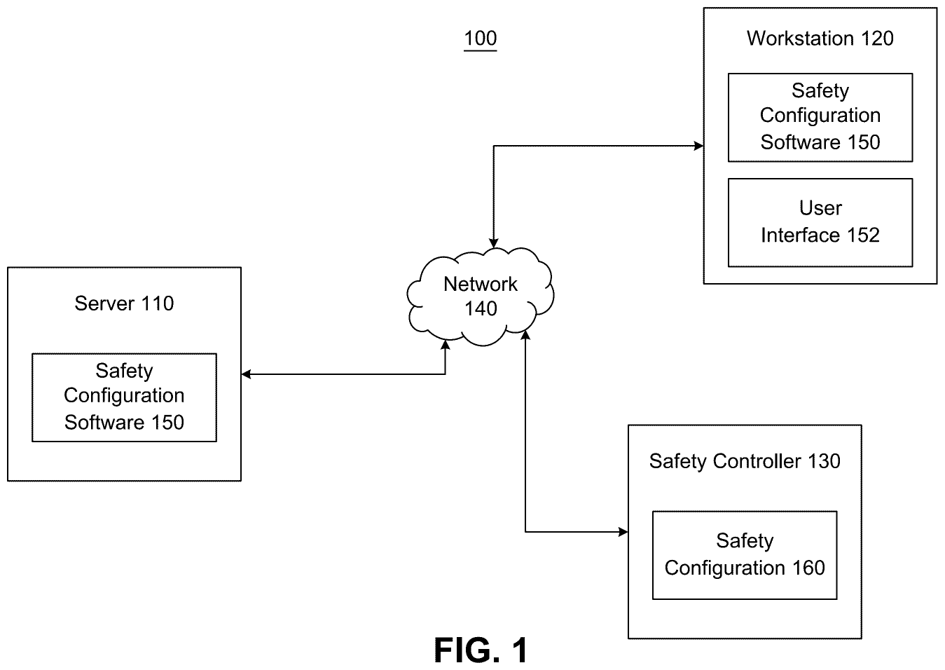

Referring to FIG. 1, a block diagram showing components of an example industrial control system 100 is shown, in accordance with some aspects of the disclosure. The control system 100 can be implemented in a variety of industrial automation environments. For example, the control system 100 can be implemented in different types of manufacturing facilities in industries such as aerospace, automotive, cement, chemical processing, food and beverage, household and personal care, life sciences, marine operations, metals processing, mining operations, oil and gas, power generation, print and publishing, pulp and paper, semiconductors, warehouse and fulfillment, wastewater treatment, and other types of facilities. The control system 100 is shown to include a server 110, a workstation 120, a safety controller 130, a network 140, safety configuration software 150, a user interface 152, and a safety configuration 160. These components of the control system 100 can provide more dynamic safety functionality within a given industrial automation environment. Specifically, the control system 100 can use hierarchal safety signatures to verify the integrity of safety applications executed by the control system 100. In some examples, the hierarchal safety signatures used by the control system 100 can apply to the entire safety portion of a given controller project. The ability to create, record, and verify the safety signatures used by the control system 100 can be important for compliance and safety integrity purposes.

The safety configuration software 150 can generally be used by one or more users to generate, access, modify, download, verify, and/or perform other functions in relation to the safety configuration 160 on the safety controller 130. The safety configuration software 150 can also be used to perform various other operations associated with the control system 100. The safety configuration software 150 can be implemented as a software application (e.g., containing a set of machine-readable instructions) hosted on the server 110 and/or downloaded on the workstation 120. The server 110 can be implemented in a variety of ways, including using multiple separate devices in communication with one another or as a standalone system or device. For example, the server 110 can be implemented using one or more remote server computers operating in a data center (e.g., cloud-based servers), one or more on-premises server computers (e.g., server computers installed at a manufacturing facility), or a combination thereof (e.g., a hybrid implementation). The server 110 can include various suitable types of processing circuitry (e.g., one or more central processing units (CPUs), one or more graphics processing units (GPUs), etc.) and memory (e.g., volatile, non-volatile, random-access memory (RAM), read-only memory (ROM), electrically erasable programmable read-only memory (EEPROM), etc.). For example, the server 110 can include one or more non-transitory machine-readable storage media having instructions stored thereon that, when executed by the processing circuitry of the server 110, cause the processing circuitry of the server 110 to perform various operations in accordance with the instructions.

The workstation 120 can likewise be implemented in a variety of ways. Generally, the workstation 120 can by any suitable type of computing system that can be used by one or more users to access the safety configuration software 150. For example, the workstation 120 can be a workstation computer located in a manufacturing facility that engineers and other skilled personnel can use to access the safety configuration software 150. The workstation 120 can also be a personal computing device, such as, a laptop, a desktop computer, a tablet, a smartphone, and/or other types of personal computing devices, for example. The workstation 120 can include various suitable types of processing circuitry (e.g., CPUs, GPUs etc.) and memory (e.g., volatile, non-volatile, RAM, ROM, EEPROM, etc.). For example, the workstation 120 can include one or more non-transitory machine-readable storage media having instructions stored thereon that, when executed by the processing circuitry of the workstation 120, cause the processing circuitry of the workstation 120 to perform various operations in accordance with the instructions. Upon execution of the safety configuration software 150 by the processing circuitry of the workstation 120, the safety configuration software 150 can cause the workstation 120 to present the user interface 152 on a display of the workstation 120 to allow one or more users to perform various operations.

The safety controller 130 can be any suitable type of device used within the control system 100 to perform safety functionality. For example, the safety controller 130 can be various types of safety programmable controllers used in the broader industrial automation environment associated with the control system 100. For example, the safety controller 130 can be implemented as a programmable logic controller (PLC), an application-specific integrated circuit (ASIC) based control device, and/or implemented as an industrial personal computer (IPC). The safety controller 130 can also include and/or be connected to various types of safety sensors, switches, relays, and/or other types of safety devices. The safety controller 130 can detect and/or receive indications of faults and other safety alerts that occur within the industrial automation environment associated with the control system 100. For example, the safety controller 130 can detect and/or receive indications of short circuit events, overcurrent events, safety alarm events, and extreme sensor readings, among other possibilities.

The safety controller 130 can generally execute instructions defined by the safety configuration 160 that is configured by one or more users via the safety configuration software 150 and downloaded to the safety controller 130 (e.g., via the network 140) to perform safety operations. For example, the safety controller 130 can be a safety-certified device that is configurated to generate one or more safety signatures (e.g., the safety signature 200 discussed below) in accordance with the safety configuration 160. The safety controller 130 can include various suitable types of processing circuitry (e.g., CPUs, GPUs etc.) and memory (e.g., volatile, non-volatile, RAM, ROM, EEPROM, etc.). For example, the workstation 120 can include one or more non-transitory machine-readable storage media having instructions stored thereon that, when executed by the processing circuitry of the safety controller 130, cause the processing circuitry of the safety controller 130 to perform various operations in accordance with the instructions. The safety controller 130 can include one or more non-transitory computer-readable media that store instructions for operating in accordance with the safety configuration 160.

The network 140 can include any suitable types and/or combinations of electronic communications networks used in the control system 100, including wired and/or wireless communication networks using any suitable communications protocol or combination of communications protocols (e.g., Ethernet/IP, universal serial bus (USB), Wi-Fi, etc.). The server 110, the workstation 120, and/or the safety controller 130 can be connected to the network 140 such that the server 110, the workstation 120, and/or the safety controller 130 can electronically communicate with each other. In some examples, the safety controller 130 can be a ControlLogix® or GuardLogix® 5580 controller as provided by Rockwell Automation, Inc.

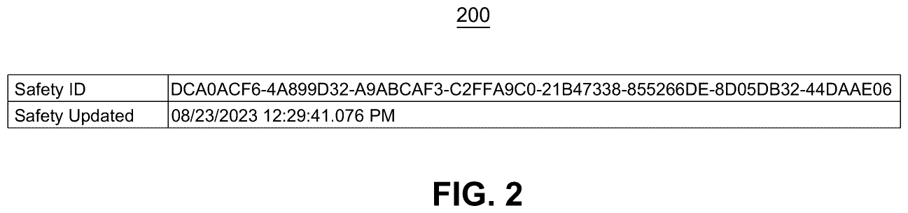

Referring to FIG. 2, an example safety signature 200 that can be used by the control system 100 is shown, in accordance with some aspects of the disclosure. The safety signature 200 as shown is an aggregate signature (e.g., Safety ID) representing the validity of multiple safety signature elements. For example, the safety signature elements can include one or more safety tasks along with programs and routines associated with the safety tasks. The cascading of safety signature elements can help users during impact analysis by efficiently and effectively identifying the changes within a given controller project. For example, if a given validation plan for the industrial automation environment does not require revalidation of unchanged safety signature elements, the cascading of safety signature elements can provide improvements in terms of reducing certification efforts.

The safety signature elements of the safety signature 200 can be generated at the time when the safety controller 130 generates the safety signature 200. The safety signature elements of the safety signature 200 can also be generated at the time when a user generates a safety signature for a given controller project using the safety configuration software 150. For example, the safety configuration software 150 can receive a user input including the safety configuration 160 based on one or more interactions with the user interface 152. Then, the safety controller 130 can generate the safety signature 200 responsive to executing the safety configuration 160, or the safety configuration software 150 can generate the safety signature 200 based on the safety configuration 160. As shown, the safety signature 200 includes a safety signature identifier (Safety ID). The Safety ID can be a unique 64-character alphanumeric identification number, among other possible implementations. The safety signature 200 also includes a time stamp indicating the date and time of a most recent change that was made to the safety signature via the safety configuration software 150. The timestamp of the safety signature 200 can be indicative of a time when the safety controller 130 generates the safety signature 200, for example.

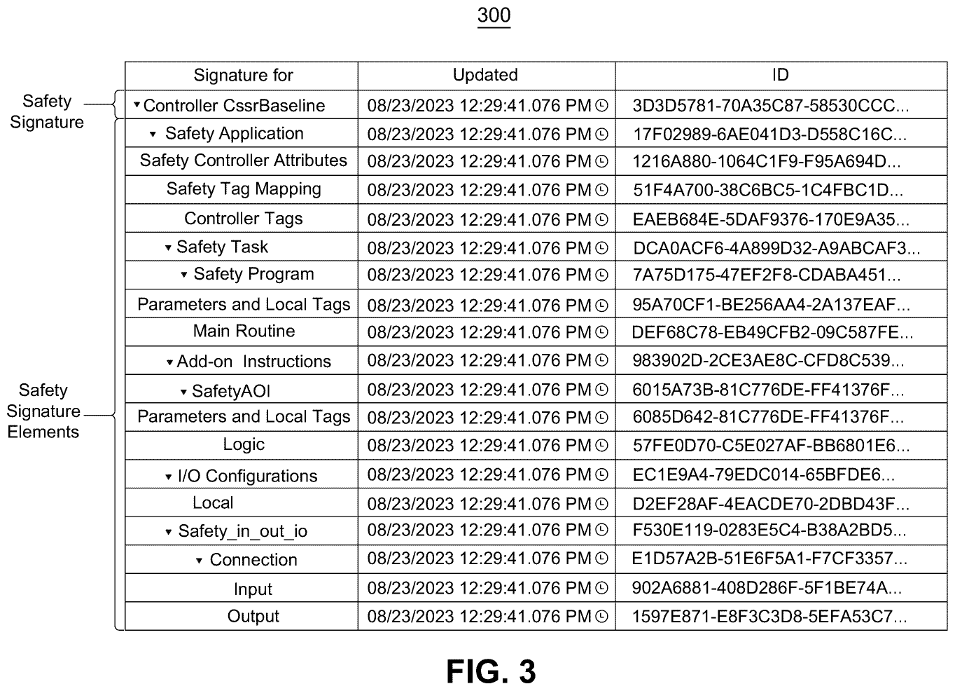

Referring to FIG. 3, an example table 300 showing safety signature hierarchy within the control system 100 is shown, in accordance with some aspects of the disclosure. The table 300 includes a safety signature with a Safety ID and a timestamp for each safety signature element in the hierarchy. The table 300 can be accessed via the safety configuration software 150 to view relationships between safety signature elements. For example, a user can expand various safety signature elements within the table 300 via the user interface 152 to view underlying signature elements (e.g., expand a parent safety signature element to view underlying child safety signature elements). Safety signature elements used within the control system 100 that include a collection of tags and parameters can have associated aggregate (cascaded) safety signatures that represent the validity of all tags and parameters within the safety element. For example, safety signature elements such as controller-scoped safety tags, safety program parameters and tags, safety add-on instructions, safety mapped tags, and/or safety input/output (I/O) connections can have associated aggregate safety signatures within the control system 100.

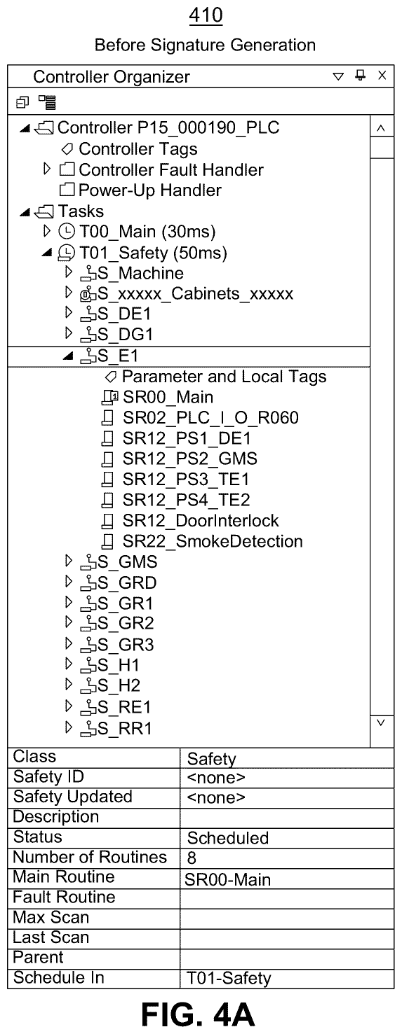

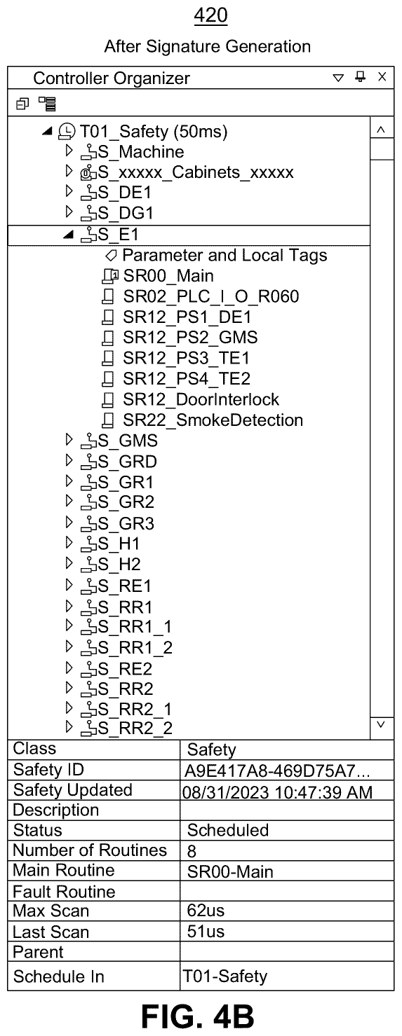

Referring to FIG. 4A, an example quick view pane interface 410 associated with the control system 100 is shown, in accordance with some aspects of the disclosure. Referring to FIG. 4B, another example quick view pane interface 420 associated with the control system 100 is shown in accordance with some aspects of the disclosure. The safety configuration software 150 can cause the quick view pane interface 410 and the quick view pane interface 420 to be presented via the user interface 152, for example. As shown, both the quick view pane interface 410 and the quick view pane interface 420 are overlaid on a controller organizer tree. The controller organizer tree can show a variety of information for a given controller project (e.g., a controller project associated with the safety controller 130) organized in a logical fashion. When a user selects any of the safety elements shown in the controller organizer tree (e.g., a safety program), the safety configuration software 150 can cause the associated safety signature to be presented in the quick view pane. In the quick view pane interface 410, a safety signature for the selected safety element has not yet been generated, so no safety signature appears. However, in the quick view pane interface 420, the safety signature has been generated and does appear. The quick view pane can provide added efficiency in terms of validation efforts.

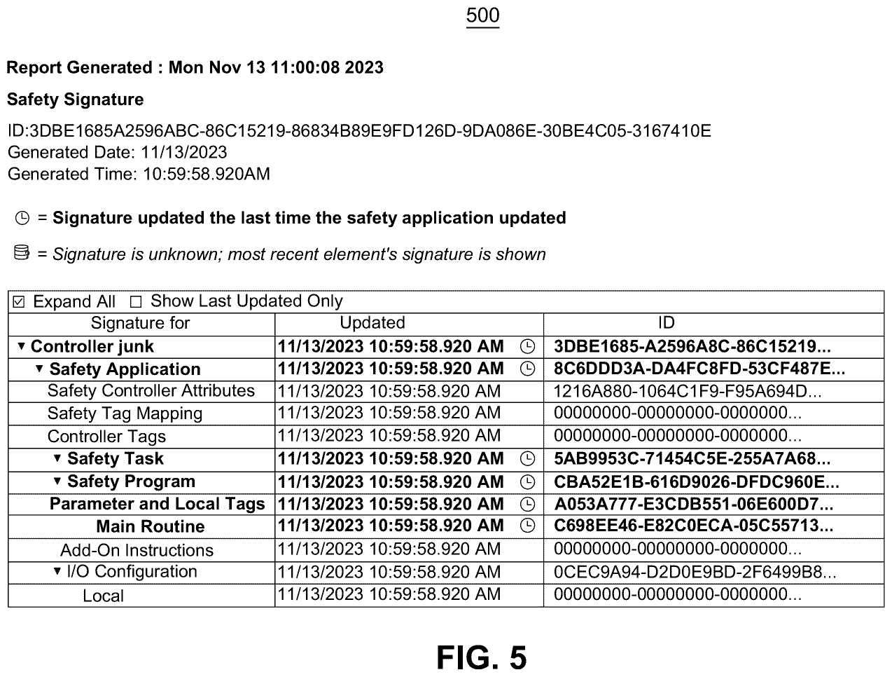

Referring to FIG. 5, an example safety signature report interface 500 associated with the control system 100 is shown, in accordance with some aspects of the disclosure. The safety configuration software 150 can cause the safety signature report interface 500 to be presented via the user interface 152, for example. As shown, the safety signature report shown via the safety signature report interface 500 includes all safety signature elements for a given controller project. In some examples, the safety configuration software 150 can cause the safety signature report interface 500 to be presented via a web browser. The safety signature report can include a safety signature in the report header, a table including the safety signature elements (e.g., similar to the table 300), and visual indicators showing the state of the safety signature elements. Historical safety signature reports can be saved using various file types for recordkeeping.

The visual indicators can include different colors, tooltips, icons, and/or other types of visual indicators presented via the user interface 152 to indicate changes to safety signatures and associated elements. For example, the safety configuration software 150 can cause safety signature elements to be presented on the safety signature report interface 500 in a blue color after the first generation of the safety signature and/or after any subsequent generation of the safety signature to indicate a modification to a safety element or one of its child elements, including additions of new child elements. The safety configuration software 150 can then cause safety signature elements to be presented on the safety signature report interface 500 in a black color after subsequent generation of the safety signature when no change has occurred to the safety element or to any of its child elements, for example. The safety configuration software 150 can cause safety signature elements to be presented on the safety signature report interface 500 in a gray color to indicate an unknown signature that occurs when the safety configuration software 150 cannot verify that the ID matches the associated value (e.g., when importing a controller project of copying a safety signature element with an existing signature). This safety signature report functionality can again provide added efficiency in terms of validation efforts.

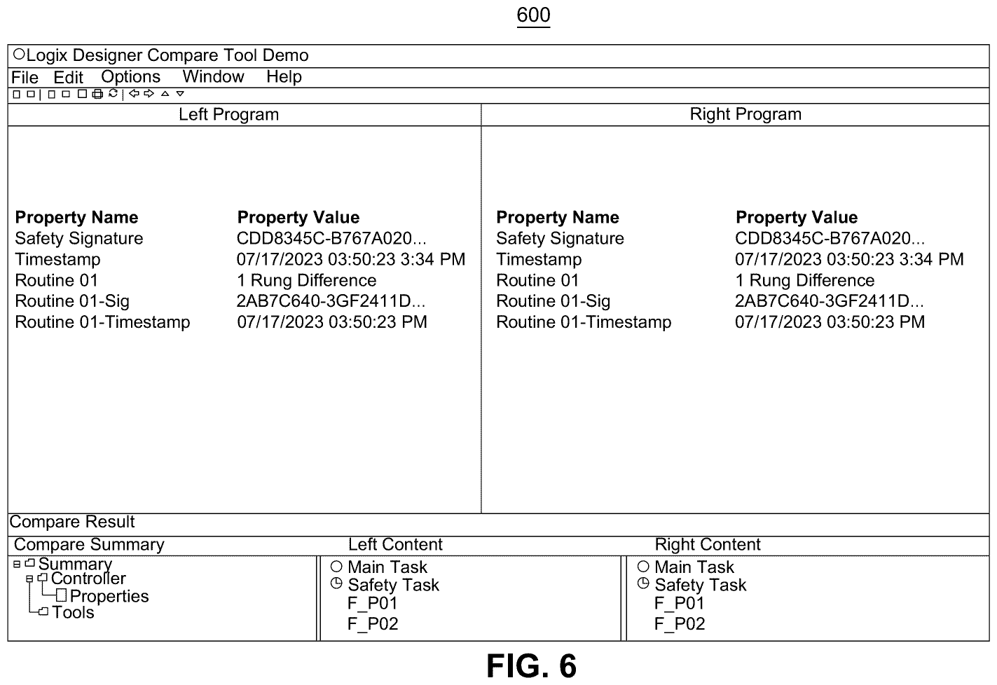

Referring to FIG. 6, an example safety signature compare tool interface 600 associated with the control system 100 is shown, in accordance with some aspects of the disclosure. The safety configuration software 150 can cause the safety signature compare tool interface 600 to be presented via the user interface 152, for example. Via the safety configuration software 150, a user can use the safety signature compare tool to compare the safety signature elements in two or more distinct controller projects and efficiently identify differences between the safety signature elements in the two or more distinct controller projects. The example safety signature compare tool interface 600 as shown in FIG. 6 provides the user with a comparison of two safety routines (e.g., two child safety signature elements that are associated with a parent safety program signature element). The safety signature compare tool can again provide added efficiency in terms of validation efforts.

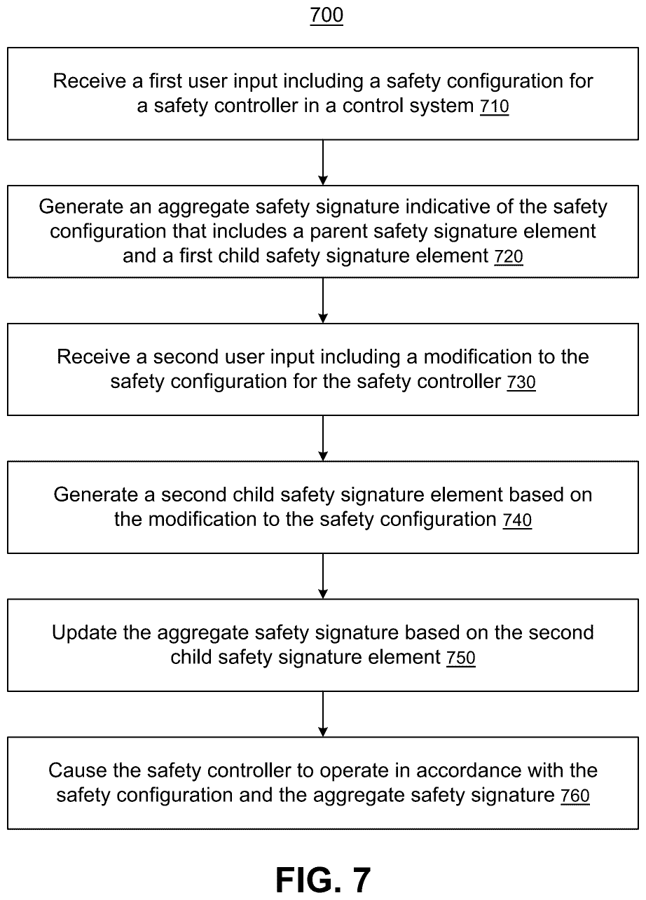

Referring to FIG. 7, a flow diagram illustrating an example process 700 for generating and using hierarchal cascading safety signatures that can be implemented in the control system 100 is shown, in accordance with some aspects of the disclosure. The process 700 can be performed by the server 110 and/or the workstation 120, for example. The process 700 can generally be used to provide help to users during impact analysis by efficiently and effectively identifying the changes within a given controller project (e.g., changes within the safety configuration 160 that is executed by the safety controller 130). For example, if a given validation plan for the control system 100 does not require revalidation of unchanged safety signature elements, the cascading of safety signature elements can provide improvements in terms of reducing certification efforts necessary for the control system 100 to operate in accordance with various safety standards.

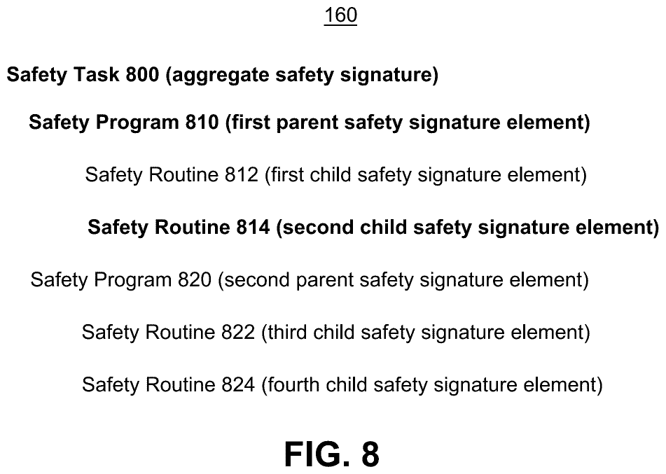

At 710, the process 700 can include receiving a first user input that includes a safety configuration for a safety controller in the control system. For example, at 710, the server 110 and/or the workstation 120 can receive a user input entered via the user interface 152, where the user input includes the safety configuration 160 for the safety controller 130 in the control system 100. The user input received at 710 can be based on one or more interactions (e.g., selection of user interface elements, voice inputs, etc.) between the user and the user interface 152. To help illustrate the functionality performed as part of the process 700, let us consider a specific example hierarchal relationship between an aggregate safety signature and its associated parent and child safety signature elements as shown in FIG. 8.

In FIG. 8, the safety configuration 160 includes a safety task 800 for performing by the safety controller 130. The safety task 800 includes both a safety program 810 that is associated with a first parent safety signature element as well as a safety program 820 that is associated with a second parent safety signature element. The safety program 810 includes a safety routine 812 and a safety routine 814. The safety routine 812 is associated with a first child safety signature element, the safety routine 814 is associated with a second child safety signature element, and both the first child safety signature element and the second child safety signature element are associated with the first parent safety signature element. Similarly, the safety program 820 includes a safety routine 822 and a safety routine 824. The safety routine 822 is associated with a third child safety signature element, the safety routine 824 is associated with a fourth child safety signature element, and both the third child safety signature element and the fourth child safety signature elements are associated with the second parent safety signature element.

At 720, the process 700 can include generating an aggregate safety signature that is indicative of the safety configuration and includes both a parent safety signature element and a first child safety signature element. For example, at 720, the server 110 and/or the workstation 120 can execute the safety configuration software 150 to generate the safety signature 200, and the safety signature 200 can be indicative of the safety configuration 160 for the safety controller 130. In continuing with the example hierarchal relationship as shown in FIG. 8, the aggregate safety signature generated at 720 can be the aggregate safety signature associated with the safety task 800. Then, the parent safety signature element generated at 720 can be the first parent safety signature element that is associated with the safety program 810, and the first child safety signature element generated at 720 can be the first child safety signature element that is associated with the safety routine 812. The aggregate safety signature generated at 720 can also include the second child safety signature element associated with the safety routine 814, the second parent safety signature associated with the safety program 820, the third child safety signature element associated with the safety routine 822, and the fourth child safety signature element associated with the safety routine 824.

The aggregate safety signature associated with the safety task 800 can include the first parent safety signature element that is associated with the safety program 810, the first child safety signature element that is associated with the safety routine 812, the second child safety signature element associated with the safety routine 814, the second parent safety signature associated with the safety program 820, the third child safety signature element associated with the safety routine 822, and the fourth child safety signature element associated with the safety routine 824 in various suitable manners. For example, the safety configuration software 150 can generate the aggregate safety signature associated with the safety task 800 by using various types of functions (e.g., hashing functions, concatenation functions, etc.) to combine the first parent safety signature element that is associated with the safety program 810, the first child safety signature element that is associated with the safety routine 812, the second child safety signature element associated with the safety routine 814, the second parent safety signature associated with the safety program 820, the third child safety signature element associated with the safety routine 822, and the fourth child safety signature element associated with the safety routine 824 into the aggregate safety signature associated with the safety task 800. The aggregate safety signature associated with the safety task 800 can represent the validity of the first parent safety signature element that is associated with the safety program 810, the first child safety signature element that is associated with the safety routine 812, the second child safety signature element associated with the safety routine 814, the second parent safety signature associated with the safety program 820, the third child safety signature element associated with the safety routine 822, and the fourth child safety signature element associated with the safety routine 824.

At 730, the process 700 can include receiving a second user input that includes a modification to the safety configuration for the safety controller. For example, at 730, the server 110 and/or the workstation 120 can receive a second user input entered via the user interface 152, where the second user input includes a modification to the safety configuration 160 for the safety controller 130 in the control system 100. The second user input received at 730 can be based on one or more interactions (e.g., selection of user interface elements, voice inputs, etc.) between the user and the user interface 152. The user can modify the safety configuration 160 for any of a variety of suitable reasons. In continuing with the example hierarchal relationship as shown in FIG. 8, the modification to the safety configuration 160 received via the second user input at 730 can include a modification to the safety routine 814. For example, the user can modify one or more instructions and/or parameters associated with the safety routine 814 (e.g., time periods, safety tags, counters, safety I/O configurations, etc.). As another example, the user can also modify the safety configuration 160 at 730 by adding new things (e.g., new safety routines, etc.) to the safety configuration 160.

At 740, the process 700 can include generating a second child safety signature element based on the modification to the safety configuration. For example, based on the second user input received at 730, the server 110 and/or the workstation 120 can execute the safety configuration software 150 to generate the second child safety signature element. In continuing with the example hierarchal relationship as shown in FIG. 8, where the modification at 730 includes modification to the safety routine 814, the safety configuration software 150 can update the second child safety signature element associated with the safety routine 814 at 740. In other examples, the second child safety signature element generated at 740 can be a brand new safety signature element that has not been generated before.

At 750, the process 700 can include updating the aggregate safety signature based on the second child safety signature element. For example, based on the second child safety signature element that is generated at 740, the server 110 and/or the workstation 120 can execute the safety configuration software 150 to update the safety signature 200 as necessary. In continuing with the example hierarchal relationship as shown in FIG. 8, where the modification at 730 includes modification to the safety routine 814, the safety configuration software 150 can update the aggregate safety signature associated with the safety task 800 based on the second child safety signature element generated at 740. Additionally, the safety configuration software 150 can update the first parent safety signature element that is associated with the safety program 810 based on the second child safety signature element generated at 740. As such, the safety configuration software 150 can update aggregate safety signature associated with the safety task 800 based on both the second child safety signature element generated at 740 and the updated first parent safety signature element that is associated with the safety program 810.

The safety configuration software 150 can update the aggregate safety signature associated with the safety task 800 and the first parent safety signature element that is associated with the safety program 810 based on the second child safety signature element generated at 740 in various suitable manners. For example, the safety configuration software 150 can again use one or more suitable functions (e.g., hashing functions, concatenation functions, etc.) to update the aggregate safety signature associated with the safety task 800 and the first parent safety signature element that is associated with the safety program 810 based on the second child safety signature element generated at 740.

As shown by the bolded text in FIG. 8, the modification to the safety routine 814 and the associated second child safety signature element affects both the aggregate safety signature associated with the safety task 800 and the first parent safety signature element that is associated with the safety program 810. However, none of the first child safety signature element that is associated with the safety routine 812, the second parent safety signature associated with the safety program 820, the third child safety signature element associated with the safety routine 822, and the fourth child safety signature element associated with the safety routine 824 are affected by the modification to the safety routine 814. As such, the safety configuration software 150 can update the aggregate safety signature associated with the safety task 800 and the first parent safety signature element that is associated with the safety program 810 based on the second child safety signature element generated at 740 without updating the first child safety signature element that is associated with the safety routine 812, the second parent safety signature associated with the safety program 820, the third child safety signature element associated with the safety routine 822, and the fourth child safety signature element associated with the safety routine 824 based on the second child safety signature element generated at 740.

To help facilitate efficiencies in the certification and validation process, the configuration software 150 can accordingly cause the user interface 152 to visually indicate that the aggregate safety signature associated with the safety task 800, the first parent safety signature element that is associated with the safety program 810, and the second child safety signature element associated with the safety routine 814 were updated at 750. The configuration software 150 can also cause the user interface 152 to visually indicate that the first child safety signature element that is associated with the safety routine 812, the second parent safety signature associated with the safety program 820, the third child safety signature element associated with the safety routine 822, and the fourth child safety signature element associated with the safety routine 824 were not updated at 750. These visual indications can be presented in various suitable manners (e.g., bold text, colored text, visual icons, etc.).

At 760, the process 700 can include causing the safety controller to operate in accordance with the safety configuration and the aggregate safety signature. For example, via the safety configuration software 150 and the network 140, the server 110 and/or the workstation 120 can cause the safety configuration 160 to be transmitted to the safety controller 130 such that the safety controller 130 operates in accordance with the safety configuration 130 and the aggregate safety signature. In this manner, the safety controller 130 can affect the operation of various types of equipment (e.g., drives, conveyors, pumps, etc.) in the control system 100 in a verifiable manner that is indicated by the aggregate safety signature.

It should be noted that while the steps of the process 700 are shown in a particular order in FIG. 7, the process 700 may not include all steps shown, may include additional steps, or may include the steps in a different order.

This description uses examples to disclose the invention and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method in a control system, comprising:
receiving a first user input provided to a user interface comprising a safety configuration for a safety controller in the control system;
generating an aggregate safety signature indicative of the safety configuration for the safety controller, the aggregate safety signature comprising a parent safety signature element and a first child safety signature element associated with the parent safety signature element;
receiving a second user input provided to the user interface comprising a modification to the safety configuration for the safety controller in the control system;
generating a second child safety signature element associated with the parent safety signature element based on the modification to the safety configuration for the safety controller;
updating the aggregate safety signature based on the second child safety signature element; and
causing the safety controller in the control system to operate in accordance with the safety configuration and the aggregate safety signature.

2. The method of claim 1, wherein the aggregate safety signature represents validity of the parent safety signature element, the first child safety signature element, and the second child safety signature element.

3. The method of claim 1, wherein updating the aggregate safety signature comprises updating the aggregate safety signature element based on the second child safety signature element without updating the first child safety signature element.

4. The method of claim 1, comprising causing the user interface to present a safety signature report indicative of the aggregate safety signature, the parent safety signature element, the first child safety signature element, and the second child safety signature element.

5. The method of claim 1, comprising updating the parent safety signature element based on the second child safety signature element without updating the first child safety signature element.

6. The method of claim 5, wherein updating the aggregate safety signature based on the second child safety signature element comprises updating the aggregate safety signature based on both the second child safety signature element and the parent safety signature element.

7. The method of claim 5, comprising causing the user interface to visually indicate that the aggregate safety signature, the parent safety signature element, and the second child safety signature element were updated but the first child safety signature element was not updated.

8. A system, comprising:
memory to store instructions; and
processing circuitry to execute the instructions to:
receive a first user input comprising a safety configuration for a safety controller in a control system;
generate an aggregate safety signature indicative of the safety configuration for the safety controller, the aggregate safety signature comprising a parent safety signature element and a first child safety signature element associated with the parent safety signature element;
receive a second user input comprising a modification to the safety configuration for the safety controller in the control system;
generate a second child safety signature element associated with the parent safety signature element based on the modification to the safety configuration for the safety controller;
update the aggregate safety signature based on the second child safety signature element; and
cause the safety controller in the control system to operate in accordance with the safety configuration and the aggregate safety signature.

9. The system of claim 8, wherein the aggregate safety signature represents validity of the parent safety signature element, the first child safety signature element, and the second child safety signature element.

10. The system of claim 8, wherein the processing circuitry is to execute the instructions to update the aggregate safety signature based on the second child safety signature element without updating the first child safety signature element.

11. The system of claim 8, wherein the processing circuitry is to execute the instructions to cause the user interface to present a safety signature report indicative of the aggregate safety signature, the parent safety signature element, the first child safety signature element, and the second child safety signature element.

12. The system of claim 8, wherein the processing circuitry is to execute the instructions to update the parent safety signature element based on the modification to the safety configuration for the safety controller without updating the first child safety signature element.

13. The system of claim 12, wherein the processing circuitry is to execute the instructions to update the aggregate safety signature based on both the second child safety signature element and the parent safety signature element.

14. The system of claim 12, wherein the processing circuitry is to execute the instructions to cause the user interface to visually indicate that the aggregate safety signature, the parent safety signature element, and the second child safety signature element were updated but the first child safety signature element was not updated.

15. A non-transitory computer-readable storage medium having instructions stored thereon that, when executed by processing circuitry, cause the processing circuitry to:
receive a first user input provided to a user interface comprising a safety configuration for a safety controller in a control system;
generate an aggregate safety signature indicative of the safety configuration for the safety controller, the aggregate safety signature comprising a parent safety signature element and a first child safety signature element associated with the parent safety signature element;
receive a second user input provided to the user interface comprising a modification to the safety configuration for the safety controller in the control system;
generate a second child safety signature element associated with the parent safety signature element based on the modification to the safety configuration for the safety controller;
update the aggregate safety signature based on the second child safety signature element; and
cause the safety controller in the control system to operate in accordance with the safety configuration and the aggregate safety signature.

16. The computer-readable storage medium of claim 15, wherein the aggregate safety signature represents validity of the parent safety signature element, the first child safety signature element, and the second child safety signature element.

17. The computer-readable storage medium of claim 15, wherein the instructions, when executed by the processing circuitry, cause the processing circuitry to cause the user interface to present a safety signature report indicative of the aggregate safety signature, the parent safety signature element, the first child safety signature element, and the second child safety signature element.

18. The computer-readable storage medium of claim 15, wherein the instructions, when executed by the processing circuitry, cause the processing circuitry to update the parent safety signature element based on the second child safety signature element without updating the first child safety signature element.

19. The computer-readable storage medium of claim 18, wherein the instructions, when executed by the processing circuitry, cause the processing circuitry to update the aggregate safety signature based on both the second child safety signature element and the parent safety signature element.

20. The computer-readable storage medium of claim 18, wherein the instructions, when executed by the processing circuitry, cause the processing circuitry to cause the user interface to visually indicate that the aggregate safety signature, the parent safety signature element, and the second child safety signature element were updated but the first child safety signature element was not updated.
